(19) United States
(12) Patent Application Publication
(10) Pub. No.: US 2026/0233377 A1
(43) Pub. Date: Aug. 13, 2026

(54) HOUSING CASE AND INSERT SET

(71) Applicant: KYOCERA CORPORATION, Kyoto (JP)

(72) Inventor: Yuki YOSHIKI, Kyoto (JP)

(21) Appl. No.: 19/470,810

(22) PCT Filed: Mar. 1, 2024
(86) PCT No.: PCT/JP2024/007717

§ 371 Date: Sep. 30, 2025

(30) Foreign Application Priority Data
Apr. 3, 2023 (JP) 2023-060415

(51) Int. Cl. B25H 3/02; B65D 25/10; B65D 43/12

(52) U.S. Cl. CPC B25H 3/02; B65D 25/10; B65D 43/12

(57) ABSTRACT

To easily determine whether or not a cutting edge on the upper surface side and a cutting edge on the lower surface side of a cutting insert housed in a housing case have been already used. A case body includes a first opening portion located on an upper side, a second opening portion located on a lower side, and a housing part located inside. An insert set includes a first lid configured to open and close the first opening portion, and a second lid configured to open and close the second opening portion.

### TECHNICAL FIELD

The present disclosure relates to a housing case adapted to house a cutting insert, and an insert set in which the cutting insert is housed in the housing case.

### BACKGROUND OF INVENTION

Cutting inserts used in metallic processing are generally distributed in the market while being housed in a housing case in order to reduce defects. As a housing case for cutting inserts, a known housing case is described, for example, in Patent Document 1. The housing case described in Patent Document 1 includes a box-shaped case body including a plurality of housing parts inside for housing cutting inserts, and a lid configured to open and close an opening portion of the case body.

### CITATION LIST

### PATENT Literature

Patent Document 1: Japanese Utility Model Application Publication No. H05-071186

### SUMMARY

A housing case according to one aspect of the present disclosure is a housing case adapted to house a cutting insert, the housing case including: a case body having a frame-shape; a first lid; and a second lid. The case body includes a first opening portion located on an upper side, a second opening portion located on a lower side, and a housing part (housing space) inside adapted to house the cutting insert. The first lid opens and closes the first opening portion. The second lid opens and closes the second opening portion.

An insert set according to one aspect of the present disclosure includes: a cutting insert; and the housing case according to one aspect of the present disclosure in which the cutting insert is housed.

### BRIEF DESCRIPTION OF THE DRAWINGS

FIG. 1 is a schematic perspective view of an insert set according to an example of the present disclosure.

FIG. 2 is a schematic perspective view of the insert set according to the example of the present disclosure, illustrating a state in which a first opening portion of a case body is opened by a first lid.

FIG. 3 is a schematic perspective view of the insert set according to the example of the present disclosure, illustrating a state in which a housing case is vertically inverted.

FIG. 4 is a schematic perspective view of the insert set according to the example of the present disclosure, illustrating a state in which the housing case is vertically inverted and a second opening portion of the case body is opened by a second lid.

FIG. 5 is a schematic perspective view of a cutting insert according to the example of the present disclosure.

FIG. 6 is a schematic diagram of the cutting insert according to the example of the present disclosure, viewed from an upper surface side.

FIG. 7 is a schematic diagram of the insert set according to the example of the present disclosure, viewed from the first opening portion side of the case body.

FIG. 8 is a schematic cross-sectional view taken along line VIII-VIII in FIG. 7.

FIG. 9 is a schematic diagram of the housing case according to the example of the present disclosure, viewed from the first opening portion side of the case body.

FIG. 10 is a schematic diagram of the insert set according to the example of the present disclosure, viewed from the second opening portion side of the case body.

FIG. 11 is a schematic cross-sectional view taken along line XI-XI in FIG. 10.

FIG. 12 is a schematic diagram of the housing case according to the example of the present disclosure, viewed from the second opening portion side of the case body.

### DESCRIPTION OF EMBODIMENTS

For example, as a cutting insert to be housed in a housing case, there exist a so-called single-sided type including a cutting edge only on the upper surface side and a so-called double-sided type including cutting edges on the upper surface side and the lower surface side. In the double-sided type cutting insert, when one of the cutting edges on the upper surface side and the lower surface side is worn, the cutting insert is vertically inverted and the other of the cutting edges on the upper surface side and the lower surface side is used.

For example, in the housing case described above, of the cutting edges on the upper surface side and the lower surface side, the cutting edge located on the opening side of a housing part can be visually recognized. Therefore, it is easy to determine whether or not the cutting edge that can be visually recognized is worn, in other words, whether or not the cutting edge has been already used. However, in some cases, the cutting edge located on the bottom side of the housing part of the case body cannot be visually recognized. In this case, it is necessary to take out the cutting insert from the housing case and confirm whether or not the cutting edge located on the bottom side of the housing part of the case body has been already used.

Hereinafter, the insert set, the cutting insert, and the housing case according to the example of the present disclosure will be described in detail with reference to the drawings. Note that for explanatory convenience, each of the drawings referred to below is a simplified representation of only components necessary for describing embodiments. Therefore, the insert set, the cutting insert, and the housing case according to the example of the present disclosure may include any components not illustrated in the referenced drawings. The dimensions of the components in the drawings do not faithfully represent the actual dimensions of the components, the dimension ratios of the members, or the like.

In the present disclosure, the width direction refers to the width direction of the insert set or the housing case. The length direction refers to the length direction of the insert set or the housing case. In the drawings, “WD” refers to the width direction, “LD” refers to the length direction, “LDa” refers to one side in the length direction, “LDb” refers to the other side in the length direction, “HD” refers to the up-down direction, “HDa” refers to the upper side or upward direction, and “HDb” refers to the lower side or downward direction.

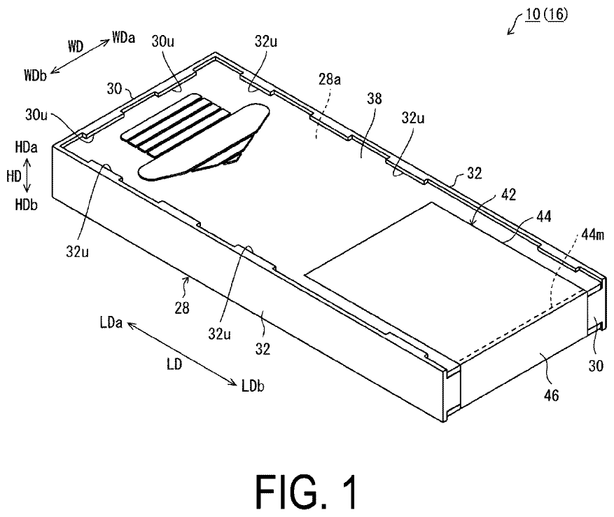

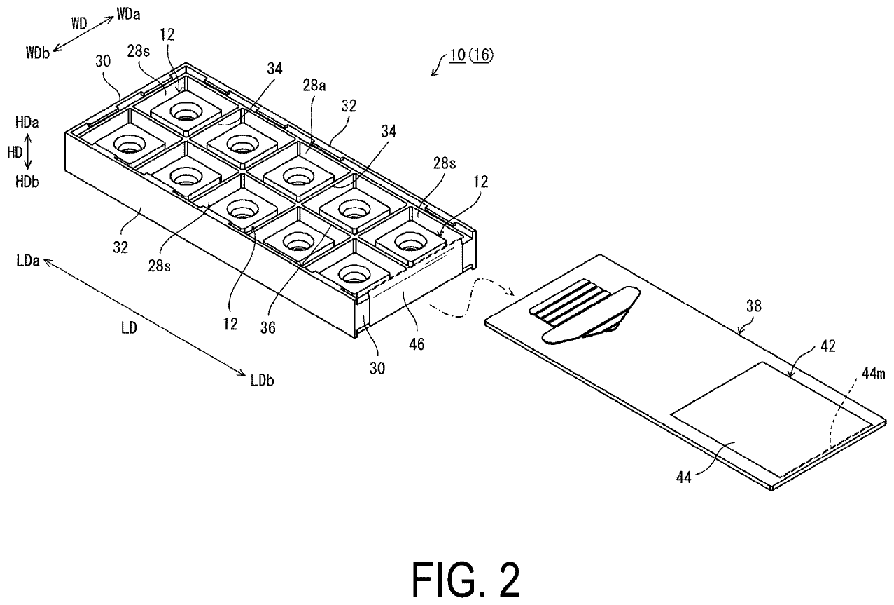

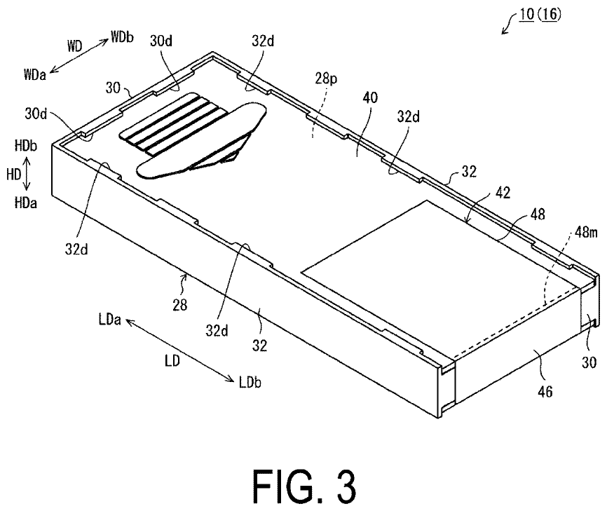

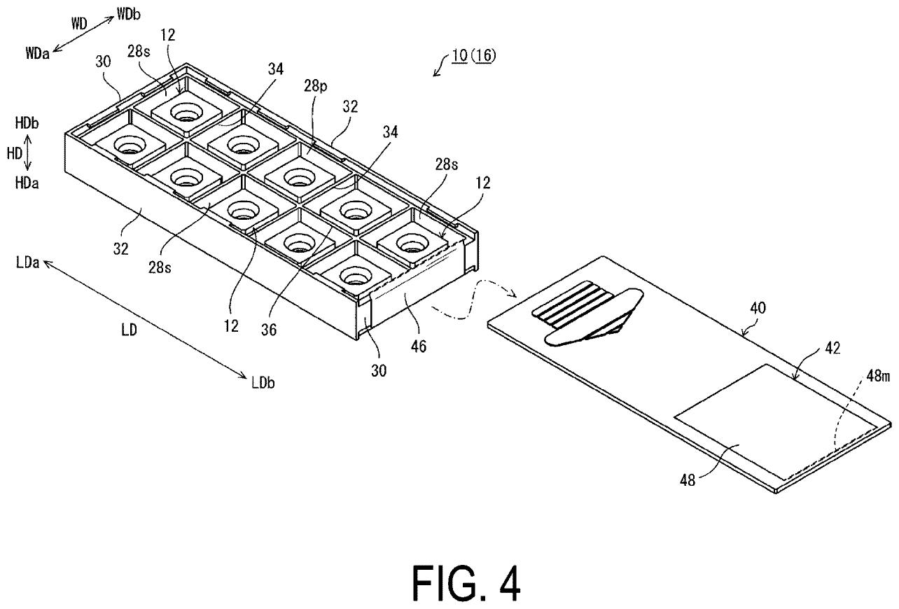

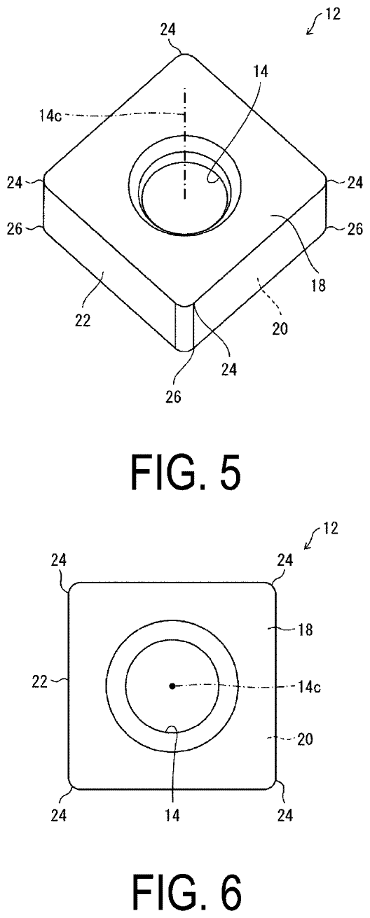

An insert set 10 and a cutting insert 12 according to an example of the present disclosure will be described with reference to FIGS. 1 to 6. FIGS. 1 to 4 are each a schematic perspective view of the insert set 10 according to the example of the present disclosure. FIG. 2 illustrates a state in which a first opening portion 28a of a case body 28 is opened by a first lid 38. FIG. 3 illustrates a state in which a housing case 16 is vertically inverted. FIG. 4 illustrates a state in which the housing case 16 is vertically inverted and a second opening portion 28p of the case body is opened by a second lid. FIG. 5 is a schematic perspective view of a cutting insert according to the example of the present disclosure. FIG. 6 is a schematic diagram of the cutting insert according to the example of the present disclosure, viewed from an upper surface side.

As in the examples illustrated in FIGS. 1 to 4, the insert set 10 according to the example of the present disclosure may include a plurality of cutting inserts 12 for cutting a workpiece made of a metal or the like, and the cutting inserts 12 may each have a through hole 14.

The cutting insert 12 may be mounted in a pocket of a holder of a cutting tool when cutting a workpiece. The cutting insert 12 may be mounted in the pocket of the holder of the cutting tool by tightening a fixing screw inserted through the through hole 14. The insert set 10 may also include the housing case 16 that houses the plurality of cutting inserts 12.

As in the examples illustrated in FIGS. 5 and 6, the cutting insert 12 may have an upper surface 18 having a quadrangular shape and a lower surface 20 having a quadrangular shape and located on the opposite side of the upper surface 18. The upper surface 18 and the lower surface 20 may each have a polygonal shape other than a quadrangular shape, such as a triangular shape. The quadrangular shape is not limited to a quadrangular shape in a strict sense, and includes a shape that can be visually recognized overall as a quadrangular shape. The polygonal shape is not limited to a polygonal shape in a strict sense, and includes a shape that can be visually recognized overall as a polygonal shape.

The cutting insert 12 may have a side surface 22 located between the upper surface 18 and the lower surface 20. The side surface 22 may be connected to the upper surface 18 and the lower surface 20. The side surface 22 may function as a flank face, and may be parallel to a central axis 14c of the through hole 14. The cutting insert 12 may be a so-called negative type cutting insert having a clearance angle of 0 degrees.

The through hole 14 of the cutting insert 12 may extend through from the upper surface 18 to the lower surface 20. One end of the through hole 14 may open to the center portion of the upper surface 18. The other end of the through hole 14 may open to the center portion of the lower surface 20.

The cutting insert 12 may include a top cutting edge 24 located at an intersection of the upper surface 18 and the side surface 22. The cutting insert 12 may include a bottom cutting edge 26 located at an intersection of the lower surface 20 and the side surface 22. In other words, the cutting insert 12 may be a double-sided insert including the top cutting edge 24 and the bottom cutting edge 26.

The top cutting edge 24 may be located over the entire intersection of the upper surface 18 and the side surfaces 22 or may be located on part of the intersection of the upper surface 18 and the side surfaces 22. The bottom cutting edge 26 may be located over the entire intersection of the lower surface 20 and the side surfaces 22 or may be located on part of the intersection of the lower surface 20 and the side surfaces 22.

When machining is performed by the top cutting edge 24, a part of the upper surface 18 may function as a rake face, and the lower surface 20 may function as a seating surface for mounting in the pocket of the holder. When machining is performed by the bottom cutting edge 26, a part of the lower surface 20 may function as a rake face, and the upper surface 18 may function as a seating surface.

An example of a material of the cutting insert 12 includes a cemented carbide alloy, a cermet, or the like. Examples of the composition of the cemented carbide alloy include WC—Co produced by adding cobalt (Co) powder to tungsten carbide (WC) and sintering the mixture, WC—TiC—Co produced by adding titanium carbide (TiC) to WC—Co, and WC—TiC—TaC—Co produced by adding tantalum carbide (TaC) to WC—TiC—Co.

The cermet is a sintered composite material obtained by compounding metal with a ceramic component, and a specific example thereof includes titanium compounds in which a titanium compound such as titanium carbide (TiC) or titanium nitride (TiN) is contained as a main component.

The surface of the cutting insert 12 may be coated with a coating film by using a chemical vapor deposition (CVD) method or physical vapor deposition (PVD) method. Examples of the composition of the coating film include titanium carbide (TiC), titanium nitride (TiN), titanium carbonitride (TiCN), alumina (Al₂O₃), and the like.

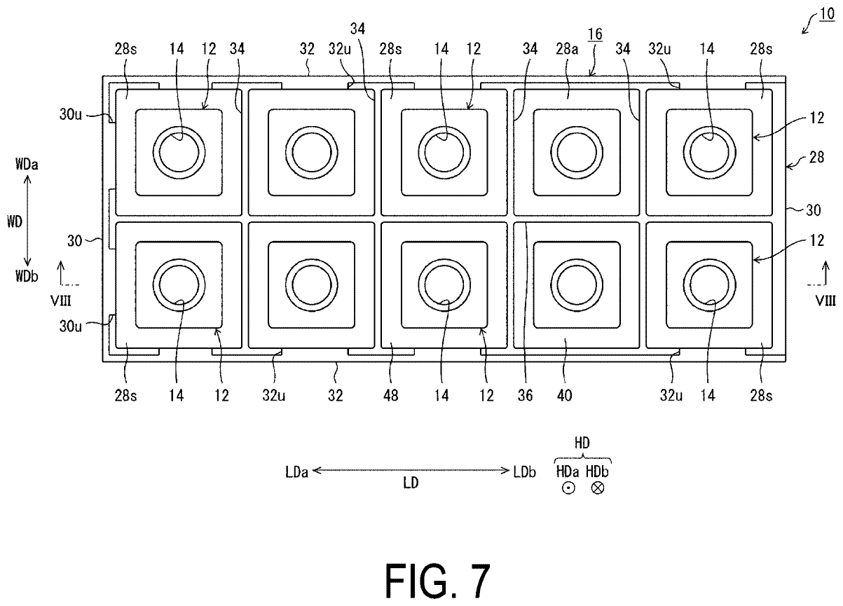

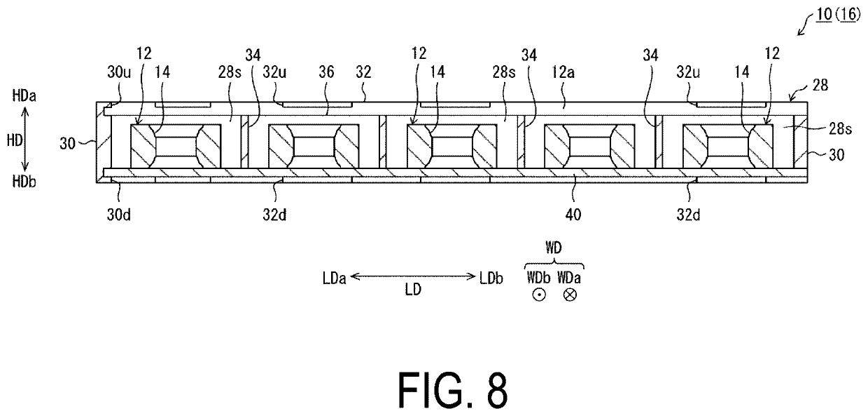

The housing case 16 according to the example of the present disclosure will be described with reference to FIGS. 1 to 4 and FIGS. 7 to 12. FIG. 7 is a schematic diagram of the insert set 10 according to the example of the present disclosure, viewed from the first opening portion 28a side of the case body 28. FIG. 8 is a schematic cross-sectional view taken along line VIII-VIII in FIG. 7.

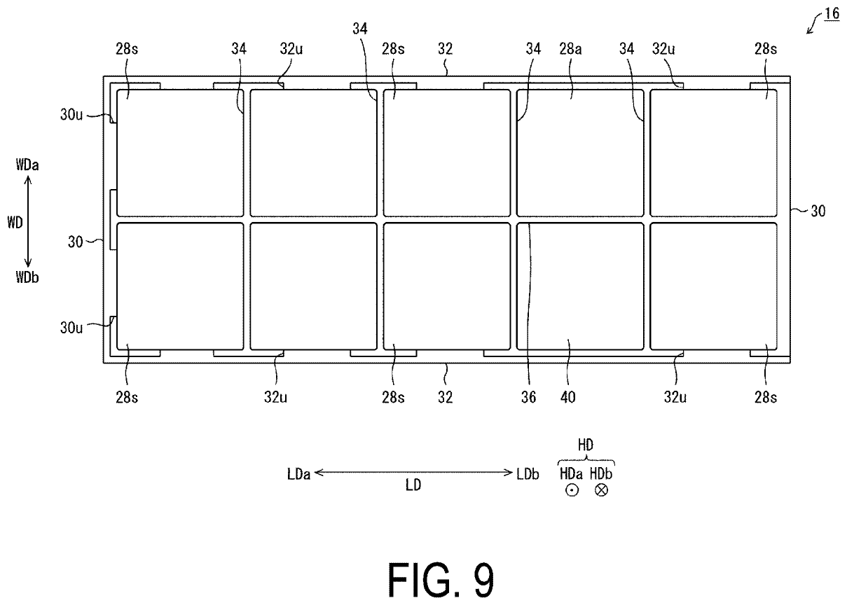

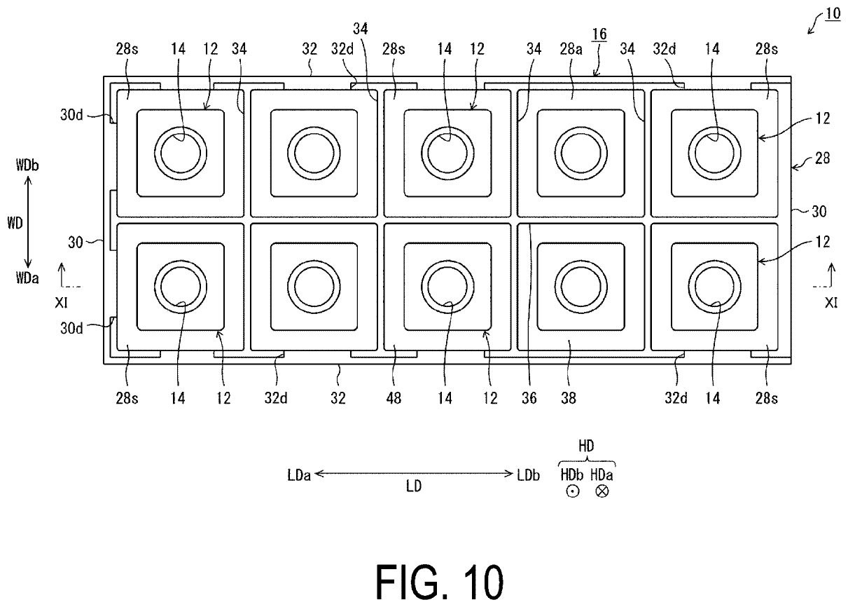

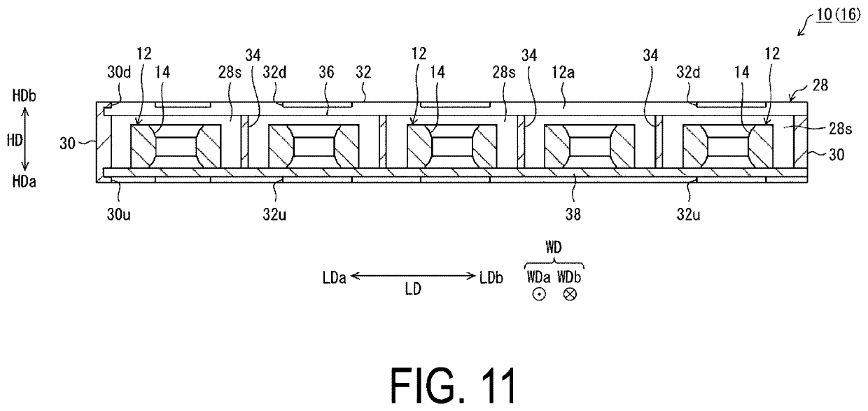

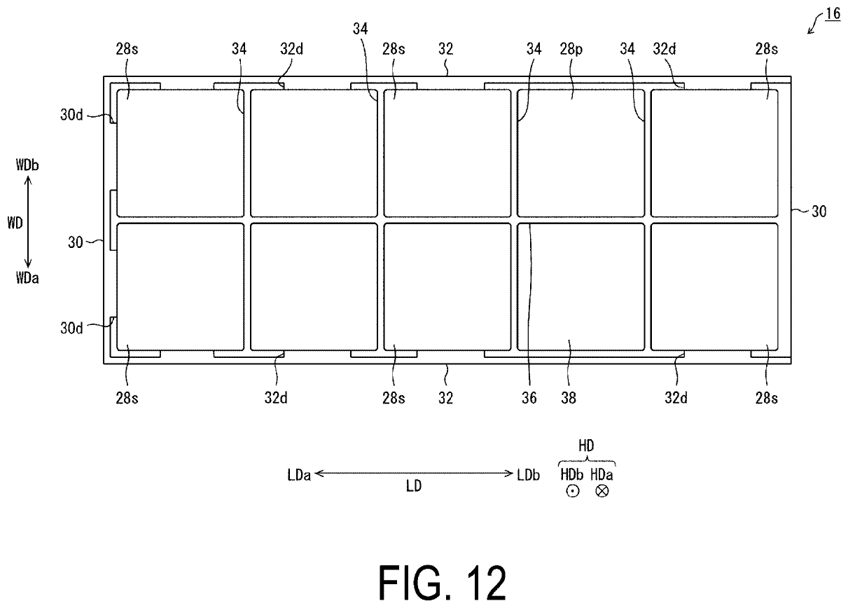

FIG. 9 is a schematic diagram of the housing case 16 according to the example of the present disclosure, viewed from the first opening portion 28a side of the case body 28. FIG. 10 is a schematic diagram of the insert set 10 according to the example of the present disclosure, viewed from the second opening portion 28p side of the case body 28. FIG. 11 is a schematic cross-sectional view taken along line XI-XI in FIG. 10. FIG. 12 is a schematic diagram of the housing case 16 according to the example of the present disclosure, viewed from the second opening portion 28p side of the case body 28.

As in the examples illustrated in FIGS. 1 to 4, the housing case 16 may include the case body 28 having a rectangular frame-shape, and the case body 28 may include the first opening portion 28a having a rectangular shape on the upper side thereof. The case body 28 may include the second opening portion 28p having a rectangular shape on the lower side thereof. Examples of a material of the case body 28 include hard resins such as polypropylene and polyethylene terephthalate.

As in the examples illustrated in FIGS. 7 to 12, the case body 28 may include a pair of first side walls 30 extending in the width direction and facing each other in the length direction, and a pair of second side walls 32 extending in the length direction and facing each other in the width direction. The outer side surface of the first side wall 30 corresponds to a side surface of the case body 28 in the length direction. The outer side surface of the second side wall 32 corresponds to a side surface of the case body 28 in the width direction.

As in the examples illustrated in FIGS. 1, 3, 8, and 12, the first side wall 30 located on one side in the length direction and the pair of second side walls 32 may each protrude upward with respect to an upper end surface of the first side wall 30 located on the other side in the length direction. The first side wall 30 located on one side in the length direction may include, at its upper end portion, a plurality of first upper pieces 30u protruding toward the inner side of the case body 28.

The plurality of first upper pieces 30u may be located at an interval in the width direction. The pair of second side walls 32 may each include, at its upper end portion, a plurality of second upper pieces 32u protruding toward the inner side of the case body 28. The plurality of second upper pieces 32u may be located at intervals in the length direction.

The first side wall 30 located on one side in the length direction and the pair of second side walls 32 may each protrude downward with respect to a lower end surface of the first side wall 30 located on the other side in the length direction. The first side wall 30 located on one side in the length direction may include, at its lower end portion, a plurality of first lower pieces 30d protruding toward the inner side of the case body 28.

The plurality of first lower pieces 30d may be located at an interval in the width direction. The pair of second side walls 32 may each include a plurality of second lower pieces 32d protruding toward the inner side of the case body 28. The plurality of second lower pieces 32d may be located at intervals in the length direction.

As in the examples illustrated in FIGS. 7 to 12, the case body 28 may include a plurality of first partition walls 34 located inside the case body 28 and extending in the width direction. The plurality of first partition walls 34 may be located at intervals in the length direction. The case body 28 may also include a second partition wall 36 located inside the case body 28 and extending in the length direction. The second partition wall 36 may be located inside the case body 28 to cross the plurality of first partition walls 34 vertically. The plurality of first partition walls 34 and the second partition wall 36 may be located in a grid pattern inside the case body 28.

The inside of the case body 28 may be partitioned by the plurality of first partition walls 34 and the second partition wall 36 into a plurality of housing parts (housing spaces) 28s for housing the cutting inserts 12. In other words, the case body 28 may include the plurality of housing parts 28s located inside the case body 28.

As in the examples illustrated in FIGS. 1 and 2, the housing case 16 may include the first lid 38 having a rectangular plate-shape that opens and closes the first opening portion 28a of the case body 28. As an example of a transparent material, examples of a material of the first lid 38 include transparent resins such as polycarbonate, polyethylene terephthalate, and polyvinyl chloride.

The first lid 38 can be moved in the length direction while being guided by the upper end portions of the pair of second side walls 32. The movement of the first lid 38 toward one side in the length direction may be restricted by the upper end portion of the first side wall 30 located on one side in the length direction. The removal of the first lid 38 from the case body 28 may be restricted by the plurality of first upper pieces 30u and the plurality of second upper pieces 32u. The first lid 38 can be removed from the case body 28 from the other side in the length direction.

As in the examples illustrated in FIGS. 3 and 4, the housing case 16 may include a second lid 40 having a rectangular plate-shape that opens and closes the second opening portion 28p of the case body 28. As an example of a transparent material, examples of a material of the second lid 40 include transparent resins such as polycarbonate, polyethylene terephthalate, and polyvinyl chloride.

The second lid 40 can be moved in the length direction while being guided by lower end portions of the pair of second side walls 32. The movement of the second lid 40 toward one side in the length direction may be restricted by a lower end portion of the first side wall 30 located on one side in the length direction. The removal of the second lid 40 from the case body 28 may be restricted by the plurality of first lower pieces 30d and the plurality of second lower pieces 32d. The second lid 40 can be removed from the case body 28 from the other side in the length direction. The second lid 40 may have the same shape as the first lid 38.

As in the examples illustrated in FIGS. 1 to 4, the insert set 10 may include a film sealing seal 42 that fixes the first lid 38 and the second lid 40 to the case body 28. The sealing seal 42 may serve as both a first sealing seal that fixes the first lid 38 to the case body 28 and a second sealing seal that fixes the second lid 40 to the case body 28.

The material of the sealing seal 42 is not particularly limited, but examples thereof include synthetic resins, for example, olefin-based resins such as polyethylene and polypropylene, and polyester-based resins such as polyethylene terephthalate and polylactic acid.

The sealing seal 42 may include an upper surface portion 44 attached to the first lid 38, a side surface portion 46 attached to the outer surface of one of the first side walls 30, and a lower surface portion 48 attached to the second lid 40.

The upper surface portion 44 of the sealing seal 42 as the first sealing seal may include a first perforation 44m that is broken when the first opening portion 28a of the case body 28 is opened for the first time by the first lid 38. The lower surface portion 48 of the sealing seal 42 as the second sealing seal may include a second perforation 48m that is broken when the second opening portion 28p of the case body 28 is opened for the first time by the second lid 40.

As in the examples illustrated in FIGS. 1 to 4, the housing case 16 according to the example of the present disclosure includes the first lid 38 that opens and closes the first opening portion 28a of the case body 28, and the second lid 40 that opens and closes the second opening portion 28p of the case body 28. Therefore, by opening the first opening portion 28a of the case body 28 by the first lid 38 in a state where the second opening portion 28p of the case body 28 is closed by the second lid 40, the upper surface 18 side of the plurality of cutting inserts 12 housed in the housing case 16 can be visually recognized from the outside (see FIG. 2).

After the housing case 16 is vertically inverted, the second opening portion 28p of the case body 28 can be opened by the second lid 40 in a state where the first opening portion 28a of the case body 28 is closed by the first lid 38. Accordingly, the lower surface 20 side of the plurality of cutting inserts 12 housed in the housing case 16 can be visually recognized from the outside (see FIG. 4).

Therefore, with the housing case 16 according to the example of the present disclosure, whether or not the top cutting edges 24 on the upper surface 18 side and the bottom cutting edges 26 on the lower surface 20 side of the plurality of cutting inserts 12 housed in the housing case 16 have been already used can be easily determined. As a result, an operation for replacing the cutting insert 12 with respect to the holder of the cutting tool, in other words, the operation of replacing the cutting insert 12 can be efficiently performed. In attempting to automate the operation for replacing the cutting insert 12, a process of taking out the cutting insert by a robot arm can be efficiently performed.

When the first lid 38 is made of a transparent material, the upper surface 18 side of the plurality of cutting inserts 12 housed in the housing case 16 can be visually recognized from the outside even in a state where the first opening portion 28a of the case body 28 is closed by the first lid 38 (see FIG. 1).

When the second lid 40 is made of a transparent material, the housing case 16 may be vertically inverted. In this case, even in a state where the second opening portion 28p of the case body 28 is closed by the second lid 40, the lower surface 20 side of the plurality of cutting inserts 12 housed in the housing case 16 can be visually recognized from the outside (see FIG. 3). Thus, the above-mentioned effect can be further enhanced.

In the housing case 16 according to the example of the present disclosure, when the first lid 38 and the second lid 40 have the same shape, just manufacturing the same components as the first lid 38 and the second lid 40 is enough, and thus manufacturing costs of the housing case 16 can be reduced.

The term “the same shape” in the present disclosure is not limited to the case where the shapes of a plurality of members are the same in a strict sense, and allows for unavoidable variations in shape, which occur in a manufacturing process, such as manufacturing error. For example, in the present disclosure, the case where the first lid 38 and the second lid 40 are manufactured using the same mold can be said that the first lid 38 and the second lid 40 have the same shape.

The insert set 10 according to the example of the present disclosure includes the housing case 16. Therefore, the insert set 10 of the present disclosure provides the same effects as the effects provided by the housing case 16 of the present disclosure.

As in the examples illustrated in FIGS. 1 and 2, the insert set 10 includes the sealing seal 42 as the first sealing seal. In this case, the insert set 10 can reduce the possibility that the first opening portion 28a of the case body 28 is opened before the first opening portion 28a of the case body 28 is intentionally opened for the first time by the first lid 38.

When the upper surface portion 44 of the sealing seal 42 as the first sealing seal includes the first perforation 44m, whether or not the first opening portion 28a of the case body 28 is opened can be confirmed (visually recognized) by the presence or absence of breaking of the first perforation 44m. This can further enhance handleability of the insert set 10.

As in the examples illustrated in FIGS. 3 and 4, the insert set 10 includes the sealing seal 42 as the second sealing seal. In this case, the insert set 10 can reduce the possibility that the second opening portion 28p of the case body 28 is opened before the second opening portion 28p of the case body 28 is intentionally opened for the first time by the second lid 40. This can enhance handleability of the insert set 10.

When the lower surface portion 48 of the sealing seal 42 as the second sealing seal includes the second perforation 48m, whether or not the second opening portion 28p of the case body 28 is opened can be confirmed (visually recognized) by the presence or absence of breaking of the second perforation 48m. This can further enhance handleability of the insert set 10.

In one embodiment, (1) a housing case adapted to house a cutting insert, the housing case including: a case body having a frame-shape and including a first opening portion located on an upper side, a second opening portion located on a lower side, and a housing part inside adapted to house the cutting insert; a first lid configured to open and close the first opening portion; and a second lid configured to open and close the second opening portion.
(2) In the housing case according to (1), the first lid and the second lid may have an identical shape.
(3) An insert set includes: a cutting insert; and the housing case according to (1) or (2) in which the cutting insert is housed.
(4) The insert set according to (3) may further include: a first sealing seal adapted to fix the first lid to the case body; and a second sealing seal adapted to fix the second lid to the case body.
(5) In the housing case according to (4), the first sealing seal may include: an upper surface portion attached to the first lid; and a side surface portion attached to a side surface of the case body, and the upper surface portion may include a first perforation that is broken when the first opening portion is opened for a first time by the first lid.
(6) In the housing case according to (4) or (5), the second sealing seal may include: a lower surface portion attached to the second lid; and a side surface portion attached to a side surface of the case body, and the lower surface portion may include a second perforation that is broken when the second opening portion is opened for a first time by the second lid.

As described above, the invention according to the present disclosure is described based on the drawings and embodiments. However, the invention according to the present disclosure is not limited to the above-described embodiments. In other words, the embodiments of the invention according to the present disclosure can be modified in various ways within the scope illustrated in the present disclosure, and embodiments obtained by appropriately combining the disclosed technical means are also included in the technical scope of the invention according to the present disclosure. In other words, note that a person skilled in the art can easily make various variations or modifications based on the present disclosure. Note that these variations or modifications are included within the scope of the present disclosure.

### REFERENCE SIGNS

10 Insert set
12 Cutting insert
14 Through hole
14c Central axis
16 Housing case
18 Upper surface
20 Lower surface
22 Side surface
24 Top cutting edge (cutting edge)
26 Bottom cutting edge (cutting edge)
28 Case body
28a First opening portion
28p Second opening portion
28s Housing part
30 First side wall
30u First upper piece
30d First lower piece
32 Second side wall
32u Second upper piece
32d Second lower piece
34 First partition wall
36 Second partition wall
38 First lid
40 Second lid
42 Sealing seal (first sealing seal, second sealing seal)
44 Upper surface portion
44m First perforation
46 Side surface portion
48 Lower surface portion
48m Second perforation

1. A housing case adapted to house a cutting insert, the housing case comprising:
a case body having a frame-shape and comprising a first opening portion located on an upper side, a second opening portion located on a lower side, and a housing part inside adapted to house the cutting insert;
a first lid configured to open and close the first opening portion; and
a second lid configured to open and close the second opening portion.

2. The housing case according to claim 1, wherein the first lid and the second lid have an identical shape.

3. An insert set, comprising:
a cutting insert; and
the housing case according to claim 1 in which the cutting insert is housed.

4. The insert set according to claim 3, further comprising:
a first sealing seal adapted to fix the first lid to the case body; and
a second sealing seal adapted to fix the second lid to the case body.

5. The insert set according to claim 4, wherein
the first sealing seal comprises:
an upper surface portion attached to the first lid; and
a side surface portion attached to a side surface of the case body, and
the upper surface portion comprises a first perforation that is broken when the first opening portion is opened for a first time by the first lid.

6. The insert set according to claim 4, wherein
the second sealing seal comprises:
a lower surface portion attached to the second lid; and
a side surface portion attached to a side surface of the case body, and
the lower surface portion comprises a second perforation that is broken when the second opening portion is opened for a first time by the second lid.
